(19) United States
(12) Patent Application Publication
(10) Pub. No.: US 2011/0235074 A1
(43) Pub. Date: Sep. 29, 2011

(54) IMAGE FORMING APPARATUS (SHEET PROCESSING APPARATUS HAVING SPEED CONTROL FUNCTION)

(75) Inventor: Hiroyuki Taguchi, Shizuoka-ken (JP)

(73) Assignees: Kabushiki Kaisha Toshiba, Tokyo (JP); Toshiba Tec Kabushiki Kaisha, Tokyo (JP)

(21) Appl. No.: 13/072,377

(22) Filed: Mar. 25, 2011

Related U.S. Application Data
(60) Provisional application No. 61/318,732, filed on Mar. 29, 2010.

(51) Int. Cl. G06K 15/00

(52) U.S. Cl. 358/1.9

(57) ABSTRACT

According to one embodiment, an image forming apparatus including an image visualizing section configured to visualize image data with a visualizing agent to obtain a visible image, an image moving section configured to move the visible image obtained by the image visualizing section to a sheet medium, a productivity setting section configured to set a number of times the image moving section moves the visible image to the sheet medium per unit time, and a sheet medium supplying section configured to supply the sheet medium from a sheet medium storing section to the image moving section at predetermined timing conforming to the number of times of the movement of the visible image set by the productivity setting section.

### CROSS-REFERENCE TO RELATED APPLICATIONS

This application is based upon and claims the benefit of priority from: U.S. Provisional Application No. 61/318,732 filed on Mar. 29, 2010, the entire contents of each of which are incorporated herein reference.

### FILED

Embodiments described herein relates generally to an image forming apparatus and sheet speed control function.

### BACKGROUND

A toner (a visualizing agent) moves to a sheet medium on the basis of image information and is integrated with the sheet medium. The sheet medium (integrated with the toner) is a hard copy.

The number of times of moving of the sheet medium (integrated with the toner) and sound (noise) caused by a mechanism of movement of the sheet medium are generally proportional to each other.

### BRIEF DESCRIPTION OF THE DRAWINGS

FIG. 1 is an exemplary diagram showing an example of an MFP, according to an embodiment;

FIG. 2 is an exemplary diagram showing an example of the MFP, according to an embodiment;

FIG. 3 is an exemplary diagram showing an example of a sheet speed control function of the MFP according to an embodiment;

FIG. 4 is an exemplary diagram showing an example of the sheet speed control function of the MFP according to an embodiment;

FIG. 5 is an exemplary diagram showing an example of the sheet speed control function of the MFP according to an embodiment;

FIG. 6A is an exemplary diagram showing an example of an interval of the sheet medium of the MFP according to an embodiment;

FIG. 6B is an exemplary diagram showing an example of an interval of the sheet medium of the MFP according to an embodiment; and

FIG. 6C is an exemplary diagram showing an example of an interval of the sheet medium of the MFP according to an embodiment.

### DETAILED DESCRIPTION

In general, according to an embodiment, an image forming apparatus comprising: an image visualizing section configured to visualize image data with a visualizing agent to obtain a visible image; an image moving section configured to move the visible image obtained by the image visualizing section to a sheet medium; and a sheet medium supplying section configured to supply the sheet medium from a sheet medium storing section to the image moving section at predetermined timing conforming to the number of times of the movement of the visible image set by the productivity setting section.

Embodiments will now be described hereinafter in detail with reference to the accompanying drawings.

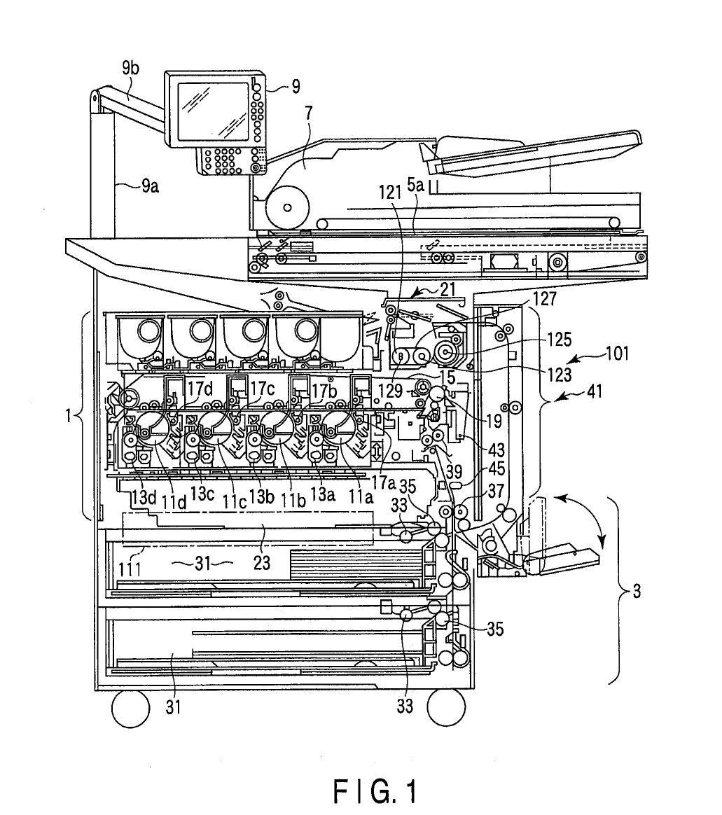

FIG. 1 schematically shows an MFP (Multi-Functional Peripheral) to which the embodiment is able to apply.

An MFP 101 includes an image forming section (a printer section) 1 for outputting image information as an output image which is referred to as a hard copy or a print out, a sheet feeder 3 to supply a sheet medium having an optional size, which is used for an image output, to the image forming section 1, a scanner section 5 to provide image data of an original to the image forming section 1, and a control section 111 to control the MFP 101.

Moreover, the scanner section 5 integrally has an automatically-document feeder (ADF) 7 the original to a reading position on the scanner section 5.

A control panel 9 to input an instruction for starting image formation in the image forming section 1 and starting to read image information of the original through the scanner section 5 is placed in a strut 9a fixed to the image forming section 1 and a swing arm 9b in a corner at a left or right side behind the scanner section 5.

The image forming section 1 includes first to fourth photoconductive drums 11a to 11d for holding latent images, developers 13a to 13d for supplying a toner to the latent images on the photoconductive drums 11a to 11d to develop toner images, a transfer belt 15 for holding the toner images transferred from the photoconductive drums 11a to 11d in order, cleaners 17a to 17d for cleaning the individual photoconductive drums 11a to 11d, a transfer roller 19 for transferring the toner image held by the transfer belt 15 onto a sheet medium, a fuser 21 for fixing the toner image transferred to the sheet medium by the transfer roller 19 onto the sheet medium, and an exposing device 23 for forming latent images on the photoconductive drums 11a to 11d.

The first to fourth developers 13a to 13d store toners having optional colors of Y (yellow), M (magenta), C (cyan) and Bk (black) which are used for obtaining a color image by a subtractive process and visualize a latent image held by each of the photoconductive drums 11a to 11d in any of the colors Y, M, C and Bk. The respective colors are determined in predetermined order corresponding to an image forming process or a characteristic of the toner.

The transfer belt 15 holds the toner images having the respective colors which are formed by the first to fourth photoconductive drums 11a to 11d and the corresponding developers 13a to 13d in order (of the formation of the toner images).

The sheet feeder 3 supplies the sheet medium to be transferred the toner image by the transfer roller 19.

Cassettes positioned in a plurality of cassette slots 31 store sheet media having optional sizes. Depending on an image forming operation, a pickup roller 33 takes the sheet medium out of the corresponding cassette. The size of the sheet medium corresponds to a size of the toner image formed by the image forming section 1.

A separating mechanism 35 prevents at least two sheet media from being taken out of the cassette by the pickup roller 33.

A plurality of delivery rollers 37 feed the sheet medium separated to be one sheet medium by the separating mechanism 35 toward an aligning roller 39.

The aligning roller 39 feeds the sheet medium to a transfer position in which the transfer roller 19 and the transfer belt 15 come in contact with each other in a timing for transferring the toner image from the transfer belt 15 by the transfer roller 19.

The fuser unit 21 includes a first roller 121, a second roller 123, a third roller 125, and a fixing belt 127 subjected to predetermined tension by the first roller 121 and the second roller 123. The first roller 121 is referred to as, for example, heating roller. The second roller 123 is referred to as fixing roller. The third roller 125 is referred to as pressing roller.

An arbitrary part of the fixing belt 127 and the outer circumference of the pressing roller 125 form a nip by pressure applied to the fixing roller 123 and the pressing roller 125. Consequently, predetermined pressure and temperature (fixing temperature) which can melt a toner are applied to the sheet medium passing through the nip such that a toner (a toner image) carried by the sheet medium can be fixed.

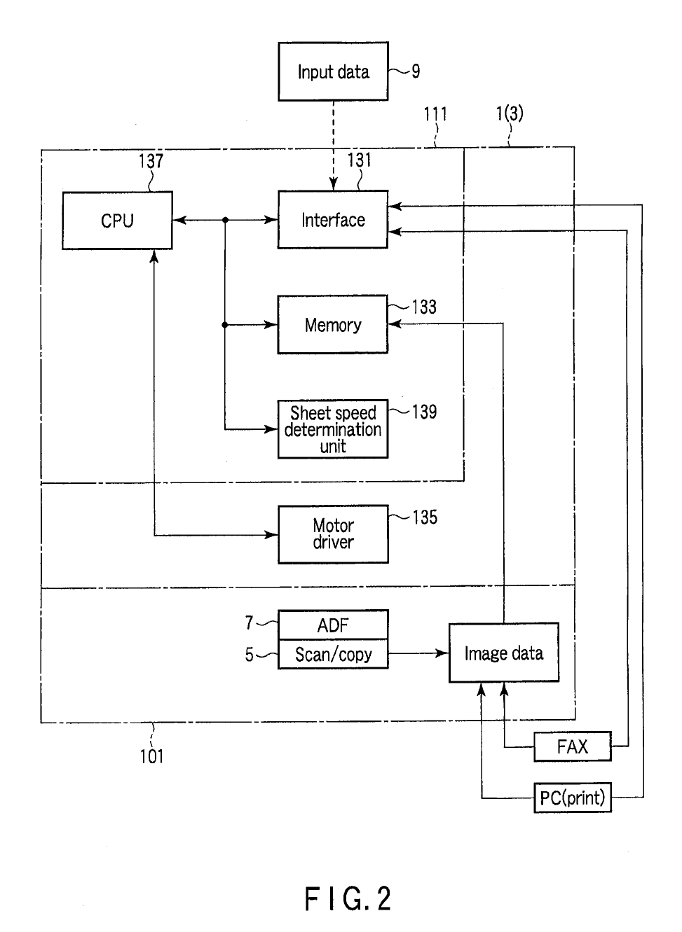

Any one of the heating roller 121, the fixing roller 123, and the pressing roller 125 is rotated at constant speed by a motor that rotates at a predetermined rotation amount according to the control by a motor driver 139 (see FIG. 2). The motor rotates at a time point when fixing temperature (of the fixing belt of the fuser 21) reaches a certain temperature (and during a fixing operation). Consequently, an arbitrary position of the fixing belt 127 moves at constant speed, which is the moving speed of the sheet medium, in a direction orthogonal to a rotation axis (of the fixing roller 123).

The fuser 21 feeds the output image to a stocker 47 positioned in a space between the scanner section 5 and the image forming section 1.

The transfer roller 19 is positioned in an automatically-duplex unit (ADU) 41 for replacing both sides of the sheet medium, that is, the output image (hard copy, print out) which has the toner image fixed thereto by the fuser 21.

The ADU 41 moves to a side (a right side) with respect to the image forming section 1, if the sheet medium is jammed between the delivery roller 37 (a final one) and the aligning roller 39 or between the aligning roller 39 and the fuser 21, that is, in the transfer roller 19 or the fuser 21. The ADU 41 integrally has a cleaner 25 for cleaning the transfer roller 19.

A media sensor 45 to detect thickness of the sheet medium conveyed to the aligning roller 39 in the path between the delivery roller 37 and the aligning roller 39. The media sensor 45 useable benefit of priority from: U.S. patent applications Ser. No. 12/197,880 filed on Aug. 25, 2008 and No. 12/199,424 filed on Aug. 27, 2008 and/or a shift of thickness detecting roller type benefit of priority from: U.S. Provisional Application No. 61/043,801 filed on Apr. 10, 2008, each of which are incorporated.

The control section 111 includes an interface unit 131 configured to receive input values from the operation unit 9 that can input control values such as the number of copies of an output image (output), an output image magnification, a size of a sheet medium, and a print start signal corresponding to image information acquired by the scanner section 5, a memory unit 133 configured to store input numerical value data (an input value), image information (image data) input by the scanner section 5, or image data (image information) supplied from a client (a PC (Personal Computer)) through a facsimile line connected to the outside or a LAN (Local Area Network), a speed control determination unit 135 configured to detect, on the basis of, for example, the number of copies of the output image (output) input by the operation unit 9 or the number of output sheets (a total number of pages) of the image data supplied through the LAN (Local Area Network), whether the number of sheets (a total number of sheets) of the output images exceed a predetermined threshold and set a changing mode for changing speed (productivity) of image formation by the image forming section 1, and a main controller (a CPU) 137 to control the sections and the units in the MFP 101.

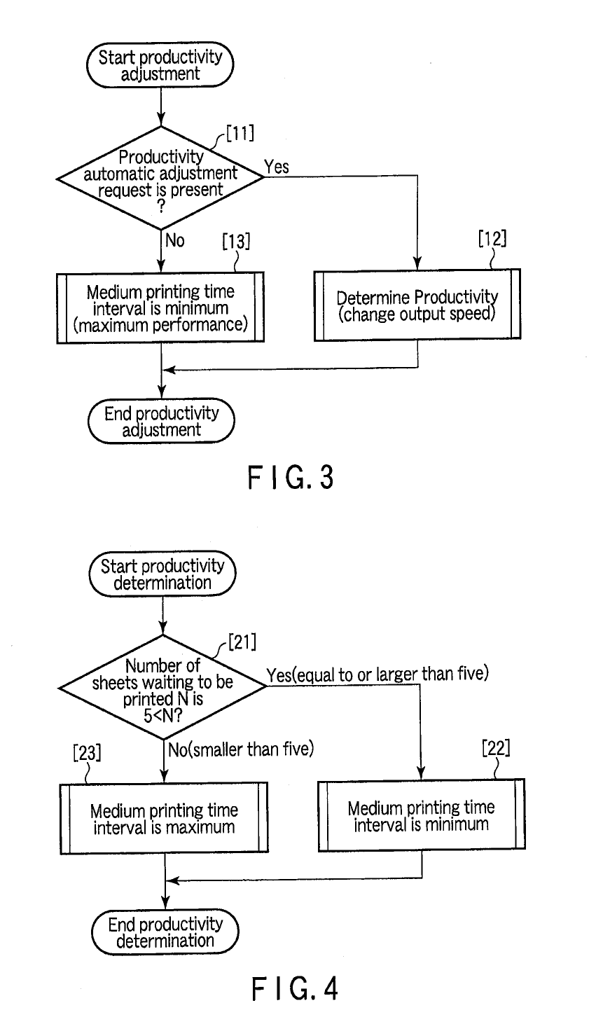

The control section 111 includes the motor driver 139 for changing operation timing of (plural or at least one) motors included in the image forming section 1 (the ADF 7) and the sheet feeder 3 according to a determination result (presence or absence of the change of the productivity) of the speed control determination unit 135 and according to classifications explained below with reference to FIGS. 3, 4, and 5. The motor driver 139 is connected to the CPU 137 and changes, according to the determination result of the speed control determination unit 135, timing for supplying a speed signal (a pulse that specifies the number of revolutions) to the (plural or at least one) motors included in the image forming section 1 (the ADF 7) and the sheet feeder 3. For example, an example shown in FIG. 3 is an example in which operation timing for the motors included in the ADF 7 and the sheet feeder 3 is maximized.

FIG. 3 is a flowchart for explaining a result of the determination by the speed control determination unit 135 and the control by the CPU 137.

For example, if it can be determined as a result of the determination by the speed control determination unit 135 that “productivity adjustment is present (applied)” is instructed [11-YES], speed for outputting output images (the number of output sheets per unit time) is changed from maximum performance to speed (the number of sheets) prepared in advance. The speed change can be realized by changing the interval at which the sheet medium is conveyed. Therefore, it is unnecessary to change the setting of exposure conditions, transfer conditions, and fixing conditions.

For example, if a target of evaluation of productivity is the volume of sound, sound generated when the pickup roller 33 moves the sheet medium from the cassette 31 and/or sound due to rotation, stop, or the like of the aligning roller 39 becomes conspicuous according to an increase in the number of output sheets per unit time of the output image. This gives the impression as if the volume of the sound increases. Therefore, concerning “image formation (output of an output image) for received facsimile data”, “image formation (output of an output image) conforming to a print request from a PC (a client)”, or the like from which it can be determined that a user is often absent near the MFP 101 (the user is far from the MFP), the output of the output images only has to be finished within time in which the user moves to near the MFP 101 in order to collect a printout (the output image). Therefore, it can be determined that “productivity adjustment is present (applied)” described above is instructed. An interval of moving of the sheet medium from the cassette 31 only has to be set to a maximum interval set in advance in the MFP 101 [12].

Specifically, if the output speed is reduced to be lower than a speed at which other users present near the MFP 101 feel that the sound (of the MFP 101) is large, it is possible to suppress the frequency of generation of the sound by the MFP 101 to a frequency with which the users do not feel that the operation sounds of the sections of the MFP 101 are large. Consequently, it is possible to simulatively cause the other users present near the MFP 101 to feel as if the sound (of the MFP 101) is reduced.

For example, during reading of image information by the scanner section 5 and image formation for the read image information when it is assumed that the user is present near the MFP 101, it is possible to reduce waiting time of the user to necessary minimum time by setting the output speed to maximum output speed at which the MFP 101 can process (minimizing an interval at which the sheet medium) is conveyed taking into account the fact that the user is present near the MFP 101 (therefore, the waiting time is desirably short) [13].

In FIG. 3, an example in which productivity is determined according to print out (a PC or a facsimile) and copying is shown. For example, as display of the operation unit 9 (button display for which control input by a touch panel is possible), together with a numerical value input section configured to input an “input value (the number of copies)”, for example, “operation sound reduction mode” display to display such as “give consideration to users around the MFP 101” for making the user less sensitive to sound generated by the MFP 101 to a degree at which the user does not feel that the operation sounds of the sections of the MFP 101 are large is prepared. Although waiting time for the user who is about to make a copy slightly increases, it is possible to simulatively cause the other users near the MFP 101 to feel that the sound (of the MFP 101) is reduced.

FIG. 4 is a flowchart for explaining an example of processing by the speed control determination unit 135 for determining presence or absence of application of productivity adjustment according to, for example, the number of output copies input from the operation unit 9 and control by the CPU 137.

For example, if the “number of copies” indicating how many copies of one original document is input from the operation unit 9 and the number of copies N is “55N (not 5<N)” [21-YES], in order to reduce the waiting time of the user to necessary minimum time, it is desirable to set speed for outputting output images (the number of output sheets per unit time) to maximum performance (minimize an interval at which the sheet medium is conveyed) [22].

On the other hand, if the input number of copies N is “5<N” [21-NO], the speed of output of the output images (the number of output sheets per unit time) is changed from the maximum performance to speed (the number of sheets) prepared in advance [23].

Specifically, even if the number of copies of the output images is small and the interval at which the sheet medium is conveyed is large, since time necessary for output of all the output images does not change substantially, it is possible to increase the output interval of the output images (the interval of the sheet medium) and suppress a frequency of generation of sound by the MFP 101 to a degree at which the users present near the MFP 101 do not feel that the sound (of the MFP 101) is large.

Consequently, it is possible to simulatively cause the other users present near the MFP 101 to feel as if the sound (of the MFP 101) is reduced.

Even if the number of output copies input (set) from the operation unit 9 is smaller than “5” and if it is evident that the number of original documents is equal to or larger than five from the volume (the number of stacks) or the like of the original documents, for example, when a document (detection) sensor of the ADF 7 detects that the original documents are set, the determination explained above may be applied (e.g., if the number of original documents is three and the number of copies is one, the interval at which the sheet medium is conveyed is increased).

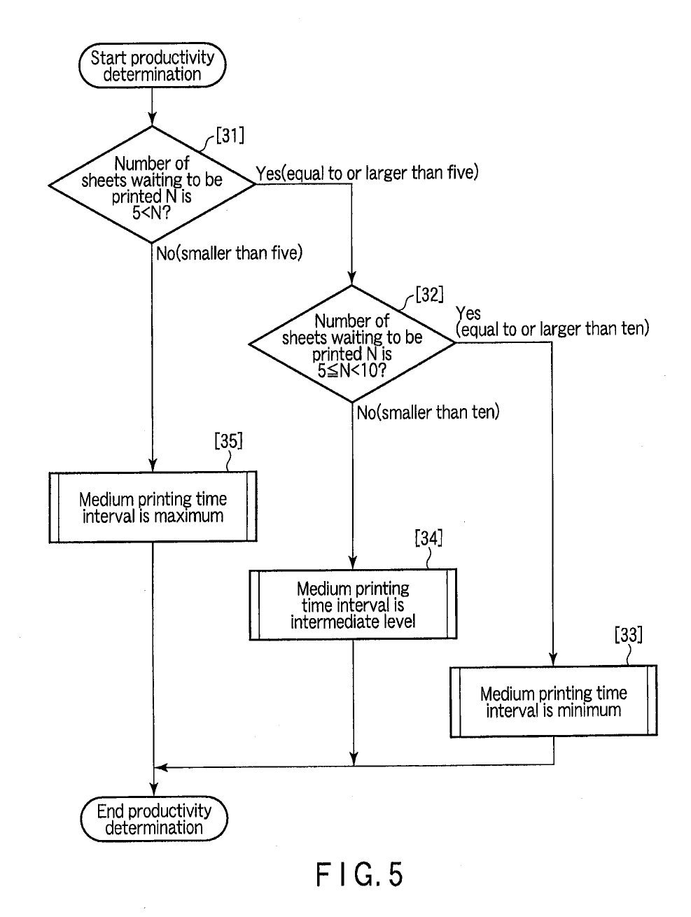

FIG. 5 is a flowchart for explaining an example of processing by the speed control determination unit 135 for determining presence or absence of application of productivity adjustment according to, for example, the number of output copies input from the operation unit 9 and control by the CPU 137.

For example, if the “number of copies” indicating how many copies of one original document is input from the operation unit 9 and the number of copies N is “5≦N (not 5<N)” [31-YES], it is further determined whether “5≦N<10 (not 10≦N)” or “10≦N” [32].

If “10≦N” [32-YES], the interval at which the sheet medium is conveyed is minimized (the maximum performance) to output the output images. This makes it possible to minimize the waiting time of the user who is about to make a copy.

If “5≦N<10 (not 10N) [32-NO], the interval at which the sheet medium is conveyed is set to an intermediate level to output the output images. Consequently, although the waiting time of the user who is about to make a copy slightly increases, it is possible to simulatively cause the other users present near the MFP 101 to feel as if the sound (of the MFP 101) is reduced.

On the other hand, if “5<N” [31-NO], the interval at which the sheet medium is conveyed is changed to a settable maximum value to output the output images. Consequently, although the waiting time of the user who is about to make a copy slightly increases, it is possible to cause the other users present near the MFP 101 to feel as if the level of “sound” is reduced to be smaller than a degree at which the users feel the sound (of the MFP 101) annoying.

Even if the number of output copies input (set) from the operation unit 9 is smaller than “5” and if it is evident that the number of original documents is equal to or larger than five from the volume (the number of laminated layers) or the like of the original documents, for example, when the document (detection) sensor of the ADF 7 detects that the original documents are set, it goes without saying that the determination explained above may be applied (e.g., if the number of original documents is three and the number of copies is one, the interval at which the sheet medium is conveyed is increased).

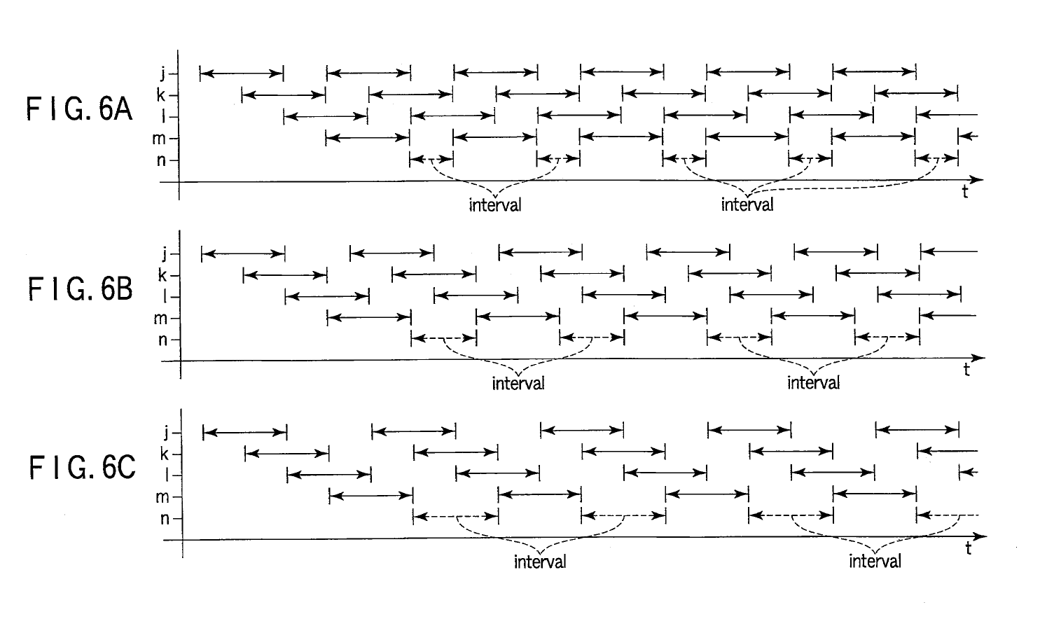

More specifically, as shown in FIGS. 6A, 6B, and 6C, a difference in the interval of the sheet medium changes the number of output sheets, i.e., the number of times of generation of sound of movement of the sheet medium from the cassette 31 by the pickup roller 33 and/or sound due to rotation, stop, or the like of the aligning roller 39, operation sound of the ADF 7, and the like.

FIG. 6A is a diagram for explaining an interval of the sheet medium during the maximum performance in FIG. 3 or 4. A j row indicates operation timing of the ADF 7, a k row indicates image formation (first to fourth photoconductive drums 11a to 11d for holding latent images, developers 13a to 13d for supplying a toner to the latent images on the photoconductive drums 11a to 11d) timing of the image forming section 1, an l row indicates timing of primary transfer to the transfer belt 15, and an m row indicates timing of secondary transfer from the transfer belt 15 to the sheet medium. An n row indicates the interval.

FIG. 6B is a diagram for explaining an interval of the sheet medium during performance at the intermediate level in FIG. 5. A j row indicates operation timing of the ADF 7 or an example in which the number of sheets or the number of copies of image data from the PC, received facsimile data, or output images is equal to or larger than five and smaller than ten, a k row indicates image formation (first to fourth photoconductive drums 11a to 11d for holding latent images, developers 13a to 13d for supplying a toner to the latent images on the photoconductive drums 11a to 11d) timing of the image forming section 1, an l row indicates timing of primary transfer to the transfer belt 15, and an m row indicates timing of secondary transfer from the transfer belt 15 to the sheet medium. The operation timing of the ADF 7 in the j row can be applied as operation timing during minimum performance in FIG. 3 such as “give consideration to users around the MFP 101”. An n row indicates the interval.

FIG. 6C is a diagram for explaining an interval of the sheet medium during the minimum performance in FIGS. 3, 4, and 5. A j row indicates an example in which the number of sheets or the number of copies of image data from the PC, received facsimile data, or output images is smaller than five, a k row indicates image formation (first to fourth photoconductive drums 11a to 11d for holding latent images, developers 13a to 13d for supplying a toner to the latent images on the photoconductive drums 11a to 11d) timing of the image forming section 1, an l row indicates timing of primary transfer to the transfer belt 15, and an m row indicates timing of secondary transfer from the transfer belt 15 to the sheet medium. The operation timing in the j row can be applied as operation timing during the minimum performance in FIG. 3 such as “give consideration to users around the MFP 101” (although an operation by the maximum performance is desirable concerning copying, if the user shows understanding, it is also possible to reduce the number of output sheets and reduce the number of times of generation of operation sound). An n row indicates the interval.

The output speed is reduced by the configuration (the speed control determination unit) explained above to be lower than a degree at which the other users present near the MFP 101 feels the sound (of the MFP 101) is large. This makes it possible to suppress the frequency of generation of sound by the MFP 101 to a frequency degree at which the users do not feel the operation sounds of the sections of the MFP 101 are large. Consequently, it is possible to simulatively cause the other users present near the MFP 101 to feel as if the sound (of the MFP 101) is reduced.

Specifically, if an instructed operation is copying, when the number of output copies (or a product of the number of original documents and the number of output copies) is smaller than five, the speed control determination unit increases the interval at which the sheet medium is conveyed to an interval set in advance. This makes it possible to simulatively cause the users to feel as if the sound (of the MFP 101) is reduced.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus comprising:
an image visualizing section configured to visualize image data with a visualizing agent to obtain a visible image;
an image moving section configured to move the visible image obtained by the image visualizing section to a sheet medium;
a productivity setting section configured to set a number of times the image moving section moves the visible image to the sheet medium per unit time; and
a sheet medium supplying section configured to supply the sheet medium from a sheet medium storing section to the image moving section at predetermined timing conforming to the number of times of the movement of the visible image set by the productivity setting section.

2. The apparatus of claim 1, further comprising:
a condition setting section configured to set, in the productivity setting section, a condition for the image visualizing section to obtain the visible image.

3. The apparatus of claim 2, wherein the condition setting section sets, on the basis of a data supply source that supplies the image data to the image visualizing section, in the productivity setting section, a condition for the image visualizing section to obtain the visible image.

4. The apparatus of claim 3, wherein the condition setting section sets, if the data supply source is a scanner, in the productivity setting section, a number of times of movement of the visible image in maximum performance.

5. The apparatus of claim 3, wherein the condition setting section sets, if the data supply source is an externally-connected apparatus, in the productivity setting section, a number of times of movement of the visible image in performance for reducing a number of times of operation of the sheet medium supplying section as compared with maximum performance.

6. The apparatus of claim 3, wherein the condition setting section sets, if the data supply source is an apparatus that supplies the image data through a communication line, in the productivity setting section, a number of times of movement of the visible image in performance for reducing a number of times of operation of the sheet medium supplying section as compared with maximum performance.

7. The apparatus of claim 1, further comprising:
a condition input section configured to input, to the productivity setting section, a condition for setting a number of times per unit time the image moving section moves the visible image obtained by the image visualizing section to the sheet medium.

8. The structure of claim 7, wherein the condition input section sets, on the basis of a number of visible images obtained by the visualizing section, in the productivity setting section, a condition for the image visualizing section to obtain the visible images.

9. The structure of claim 8, wherein the condition input section sets, if the number of visible images obtained by the visualizing section is equal to or larger than a predetermined number, in the productivity setting section, a number of times of movement of the visible images in maximum performance.

10. The structure of claim 8, wherein the condition input section sets, if the number of visible images obtained by the visualizing section is smaller than a predetermined number, in the productivity setting section, a number of times of movement of the visible images in performance for reducing a number of times of operation of the sheet medium supply section as compared with maximum performance.

11. The structure of claim 8, wherein the condition input section can input a mode for instructing the productivity setting section to change productivity and sets, when the mode is input, in the productivity setting section, a number of times of movement of the visible images in performance for reducing a number of times of operation of the sheet medium supply section as compared with maximum performance.

12. The apparatus of claim 1, further comprising:
a condition detecting section configured to detect a degree of productivity in obtaining the visible image from at least one of information concerning a data supply source that supplies the image data to the visualizing section and a number of visible images obtained by the visualizing section and set, in the productivity setting section, a condition for the image visualizing section to obtain the visible image.

13. The apparatus of claim 12, wherein the condition detecting section sets, on the basis of a number of visible images obtained by the visualizing section, in the productivity setting section, a condition for the image visualizing section to obtain the visible images.

14. The apparatus of claim 13, wherein the condition detecting section sets, if the number of visible images obtained by the visualizing section is equal to or larger than a predetermined number, in the productivity setting section, a number of times of movement of the visible images in maximum performance

15. The apparatus of claim 13, wherein the condition detecting section sets, if the number of visible images obtained by the visualizing section is smaller than a predetermined number, in the productivity setting section, a number of times of movement of the visible images in performance for reducing a number of times of operation of the sheet medium supply section as compared with maximum performance.

16. The apparatus of claim 13, wherein the condition detecting section can input a mode for instructing the productivity setting section to change productivity and sets, when the mode is input, in the productivity setting section, a number of times of movement of the visible images in performance for reducing a number of times of operation of the sheet medium supply section as compared with maximum performance.

17. A method to control a number of sheet media comprising:
visualizing image data with a visualizing agent to obtain a visible image; and
setting, in moving the obtained visible image to a sheet medium, a number of times of movement of the visible image to the sheet medium per unit time; and
supplying, at predetermined timing conforming to the set number of times of movement of the visible image, the sheet medium for movement of the obtained visible image.

18. The method of claim 17, wherein the number of times of movement is set on the basis of a data supply source that supplies the image data.

19. The method of claim 18, wherein, if the data supply source is a scanner, the number of times of movement of the visible image in maximum performance is set.

20. The method of claim 18, wherein, if the data supply source is an externally-connected apparatus, a number of times of movement of the visible image in performance for reducing a number of times of operation of the sheet supply compared with maximum performance is set.
